(19) United States
(12) Patent Application Publication
(10) Pub. No.: US 2011/0253341 A1
(43) Pub. Date: Oct. 20, 2011

(54) AUXILIARY SUPPORTS FOR HEAT EXCHANGER TUBES

(75) Inventors: Dhawi A. Al-Otaibi, Dhahran (SA); Yaagoub N. Al-Nassar, Dhahran (SA)

(73) Assignee: SAUDI ARABIAN OIL COMPANY, Dhahran (SA)

(21) Appl. No.: 12/760,401

(22) Filed: Apr. 14, 2010

(51) Int. Cl. F28F 9/013; B23P 15/26

(52) U.S. Cl. 165/69; 29/890.053; 29/401.1

(57) ABSTRACT

A method of manufacturing or modifying a tube set for a bundled tube heat exchanger, and corresponding apparatus, is provided. An elongated support member is attached to baffles in a heat exchanger. The elongated support member has opposed contoured tube-contacting surfaces and face contact surfaces. The opposed contoured tube-contacting surfaces receive, in close-fitting relation, the exterior surface of a portion of adjacent rows of tubes passing through baffle apertures. The elongated support member is positioned so that its face contact surface is adjacent to a face surface of the baffle, and the opposed contoured tube-contacting surfaces are adjacent to the exterior surfaces of the plurality of tubes. The elongated support member is attached, e.g., by welding, to the face surface of the baffle, in a manner that does not interfere with the operation of the heat exchanger.

### RELATED APPLICATIONS

Not applicable.

### BACKGROUND OF THE INVENTION

1. Field of the Invention

This invention relates to heat exchanger tube sets, and in particular to improvements in construction of heat exchanger tube sets, and methods and structures for modifying heat exchanger tube sets to eliminate or minimize vibration of tubes.

2. Description of Related Art

A bundled tube heat exchanger is a well known configuration of a heat transfer device whereby a plurality of tubes, i.e., a tube set, convey fluid that transfers heat, hereinafter referred to as a “heat transfer fluid.” By means of the thermal conductivity of the tubes, heat is transferred to a fluid contacting the exterior surface of the tubes, hereinafter referred to as the “heat receiving fluid.” In order to provide a clear basis for understanding the invention, it is appropriate to describe the prior art in conjunction with the attached drawings. FIG. 1A is a longitudinal sectional view schematically illustrating the arrangement of elements comprising a typical shell and tube heat exchanger 20 of the prior art. Exchanger 20 includes a shell 22 and a tube set 24 consisting of a plurality of tubes 26. The tubes 26 are supported at their ends with tube sheets 28, also known as end plates. In the typical construction of a bundled tube heat exchanger, a series of baffles 30 are provided through which the plurality of parallel tubes 26 pass. In the shell and tube heat exchanger 20 with plural baffles 30, the baffles 30 enhance support for the parallel tubes 26, and are provided in a staggered arrangement so as to provide a meandering pathway for the heat receiving fluid, thereby increasing turbulence, overall mixing and residence time and hence improving the efficacy of heat transfer between the outer surface of the tubes 26 and the heat receiving fluid.

In operation, a heat transfer fluid is introduced via a tube set inlet 38 proximate to a first end 34 of the shell and tube heat exchanger 20, passes through the tubes 26, and is discharged from a tube set outlet 40 proximate to the opposite end 36 of the heat exchanger 20. While the heat transfer fluid is being conveyed, the heat receiving fluid is introduced into a shell inlet 42 proximate the end portion 36. The heat receiving fluid contacts the outer surfaces of the tubes 26 as it passes over them and around the baffles 30, thereby increasing the temperature of the heat receiving fluid. The heated fluid from the shell 22 is discharged via a shell outlet 44 proximate the first end 34.

Although the shell and tube heat exchanger 20 has been described as transferring heat from the tube fluid to the shell fluid, one of ordinary skill in the art will appreciate that the shell and tube heat exchanger 20 can be used to cool a shell fluid, in which the tube fluid is a cooling fluid and the shell fluid is a cooled fluid.

The configuration of the tube set 24 is based on the configuration of the tube sheets 28 into which the tubes 26 are set. One common tube configuration is a square formation including the tubes 26 aligned in rows with paths between the tubes, i.e., tube lanes, between each pair of tubes or rows of tubes, aligned orthogonally to one another. A tube sheet 28a and a baffle 30a for this configuration are shown in FIGS. 2A and 3A, respectively. Another common tube configuration is a triangular formation, in which tubes 26 in alternate rows are aligned with one another so that each tube is adjacent six other tubes, i.e., two adjacent tubes in the same row and four tubes in the two adjacent rows. A tube sheet 28b and a baffle 30b for this configuration are shown in FIGS. 2B and 3B, respectively.

In the shell and tube heat exchanger 20, the entire tube set 24 is typically removable to facilitate tube repair or maintenance, as shown in FIG. 1B.

The dimensions of the apertures 32 in the baffles 30 as shown, for example, in FIG. 4 through which the tubes 26 pass are typically greater than the outside diameter of the tubes thereby providing a circumferential clearance region 33. One reason that the diameter of apertures 32 are greater than the outside diameter of the tubes 26 is to facilitate insertion of the tube set 24 through the baffles 30 during assembly.

However, the larger baffle apertures 32 can permit vibration of the tubes 26 during operation. After a prolonged period of service, the tubes can suffer metal fatigue and other damage due to vibrational contact with the wall of the baffle. Also, this continuous movement, although small in amplitude, can result in failure of the seals and leakage at the end plates 28 to which the tubes are either welded or rolled to secured them in position.

Various patent documents attempt to address the tube vibration problem described above. One proposed approach is to provide grids that contact the tubes at points on their outer surface to prevent vibration. For example, US2005/0161294A1 discloses a bundle of tubes having expanded metal support elements with openings to accommodate the tubes. The supporting structures are in the form of expanded metal sheets, having, e.g., a grid in the form of open diamond shapes, that fit around tubes. The grid openings contact the tubes for support. Similarly, U.S. Pat. No. 3,176,762 discloses a supporting grid with protrusions that contact the outside surface of the tube at several points. Other U.S. patents that include variations on the grid structure are shown in U.S. Pat. Nos. 3,837,397, 4,143,709, 4,336,614, 4,359,088, 4,384,697, 4,443,721, 4,665,866, 6,059,022, 7,284,598, and 7,389,811. However, the grid structures generally are installed separated from the existing baffle structures and many have multiple corners which will become fouled by accumulation of solid materials from the heat receiving fluid.

Another proposed approach is to expand the diameter of the tube in order to contact the baffles as disclosed in U.S. Pat. No. 2,021,856. Apertures are formed in the support plates with some dimensional variation as compared to the outer diameter of the tubes. The tubes are expanded at the locations of the apertures in the baffles using a swage tool disclosed in the patent. However, such a process results in non-uniform cross-section of the tubes, detrimentally impacting the fluid flow of the heat transferring fluid.

Still another approach that has been proposed in various patent documents describe what are known in the art as “tube stakes.” These tube stakes are generally elongated metal strips that are inserted between tubes in a bundle to maintain spacing, with features at the positions of the tubes for frictional engagement. Examples of various tube stakes are disclosed in US2008/024515A1 and U.S. Pat. Nos. 7,267,164 and 7,343,964. However, most of the tube stakes are use expansive resilient forces that are applied against the tubes to counter the tube vibration, and therefore expensive springs are required.

Accordingly, a need exists for an effective and inexpensive solution to problems associated with tube vibration.

Therefore, it is an object of the present invention to minimize or eliminate tube vibration, thereby preventing tube thinning and damage.

It is another object of the present invention to extend the operational lifecycle of heat exchangers by eliminating tube vibration, thereby minimizing plant production downtime in plants and processes that rely on heat exchangers.

It is still another object of the present invention to reduce induced stresses at the juncture of the tubes and the endplates, thereby minimizing or eliminating the likelihood of joint relaxation and leakage at heat exchangers endplates.

### SUMMARY OF THE INVENTION

The above objects and further advantages are provided by the method and apparatus for heat exchangers. One embodiment of the present invention is method of manufacturing or modifying a tube set for a bundled tube heat exchanger. An elongated support member is provided, having opposed contoured tube-contacting surfaces and face contact surfaces. The opposed contoured tube-contacting surfaces are configured, positioned and dimensioned to receive in close-fitting relation the exterior surface of a portion of adjacent rows of tubes passing through a baffle aperture. The elongated support member is positioned so that its face contact surface is adjacent to a face surface of the baffle, and the opposed contoured tube-contacting surfaces are adjacent to the exterior surfaces of the plurality of tubes. The elongated support member is attached, e.g., by welding, to the face surface of the baffle, in a manner that does not interfere with the operation of the heat exchanger, and in certain embodiments allows several elongated support members to be attached to the baffle atop one another.

In certain preferred embodiments, the elongated support member is cut from a component dimensioned and having apertures corresponding in size and location to the end plate of the tube set, thereby assuring close-fitting relation the exterior surface of the tubes.

In another embodiment of the present invention, a method of modifying a bundled tube heat exchanger is provided. The tube set of the heat exchanger subject to modification includes a plurality of tubes supported on their ends by end plates having apertures corresponding to a pattern of the plurality of tubes and one or more baffles intermediate the distal ends of the tubes, and the baffles are characterized by face surfaces having apertures corresponding to the pattern of the plurality of tubes through which the plurality of tubes pass. The method of modifying the bundled tube heat exchanger includes:

a) removing the tube set from the shell;

b) providing an elongated support member having opposed contoured tube-contacting surfaces configured, positioned and dimensioned to receive in close-fitting relation the exterior surface of a portion of the tubes passing through the baffle aperture, and a face contact surface;

c) positioning the elongated support member so that the face contact surface is adjacent to the face surface of the baffle and the opposed contoured tube-contacting surfaces positioned adjacent the exterior surfaces of the plurality of tubes;

d) attaching the elongated support member to the face surface of the baffle; and

e) inserting the tube set in the shell.

In a further embodiment of the present invention, a tube set for a heat exchanger is provided. The tube set includes a plurality of tubes supported on their ends by end plates, and at least one baffle intermediate to distal ends of the tubes. The baffle is characterized by a face surface having apertures corresponding to the pattern of the plurality of tubes through which the plurality of tubes pass. At least one elongated support member is attached to the baffle. The elongated support member includes a face contact surface adjacent the baffle and opposed contoured tube-contacting surfaces configured, positioned and dimensioned in close-fitting relation with the exterior surface of a portion of the tubes passing through baffle apertures.

### BRIEF DESCRIPTION OF THE DRAWINGS

The invention will be described in further detail below and with reference to the attached drawings in which the same or similar elements are referred to by the same number, and where:

FIG. 1A is a longitudinal sectional diagram of a shell and tube heat exchanger of the prior art;

FIG. 1B is a perspective view of a shell and tube heat exchanger depicting the tube set removed for tube repair or maintenance of the prior art;

FIG. 2A is a front elevation view of a tube sheet of the prior art for a shell and tube heat exchanger having the tube set in a square configuration;

FIG. 2B is a front elevation view of a tube sheet of the prior art for a shell and tube heat exchanger having the tube set in a triangular configuration;

FIG. 3A is a front elevation view of a baffle of the prior art for a shell and tube heat exchanger having the tube set in a square configuration;

FIG. 3B is a front elevation view of a baffle of the prior art for a shell and tube heat exchanger having the tube set in a triangular configuration;

FIG. 4 is an enlarged view of an aperture in a portion of a baffle and a cross-section of a tube passing through the aperture;

FIG. 5A is an end and side perspective view of an embodiment of an elongated support member of the present invention configured for use in a squarely configured tube set;

FIG. 5B is an end and side perspective view of an embodiment of an elongated support member of the present invention configured for use in a tube set in a triangular configuration;

FIG. 6A is a perspective view of a set of elongated support members in accordance with the apparatus and method of the present invention configured for use in a squarely configured tube set;

FIG. 6B is a perspective view of a set of elongated support members in accordance with the apparatus and method of the present invention configured for use in a tube set having a triangular configuration;

FIG. 7A is a front perspective view of elongated support members positioned adjacent a baffle of a heat exchanger in accordance with the present invention for enhanced support of corresponding tubes in a square configuration;

FIG. 7B is a front perspective view of elongated support members positioned adjacent a baffle of a heat exchanger in accordance with the present invention for enhanced support of corresponding tubes in a triangular configuration;

FIG. 8 schematically illustrates the sequence of inserting the elongated support members according to certain embodiments of the present invention;

FIG. 9A is a front perspective view of member from which elongated support members are formed according to an embodiment of the present invention for use with a tube set in a square configuration;

FIG. 9B is a front perspective view of member from which elongated support members are formed according to an embodiment of the present invention for use with a tube set in a triangular configuration;

FIG. 10 is a longitudinal sectional schematic diagram of a shell and tube heat exchanger according to a simulation according to an example demonstrating the present invention; and

FIG. 11 is an S-N diagram from fatigue tests for various materials.

### DETAILED DESCRIPTION OF THE INVENTION

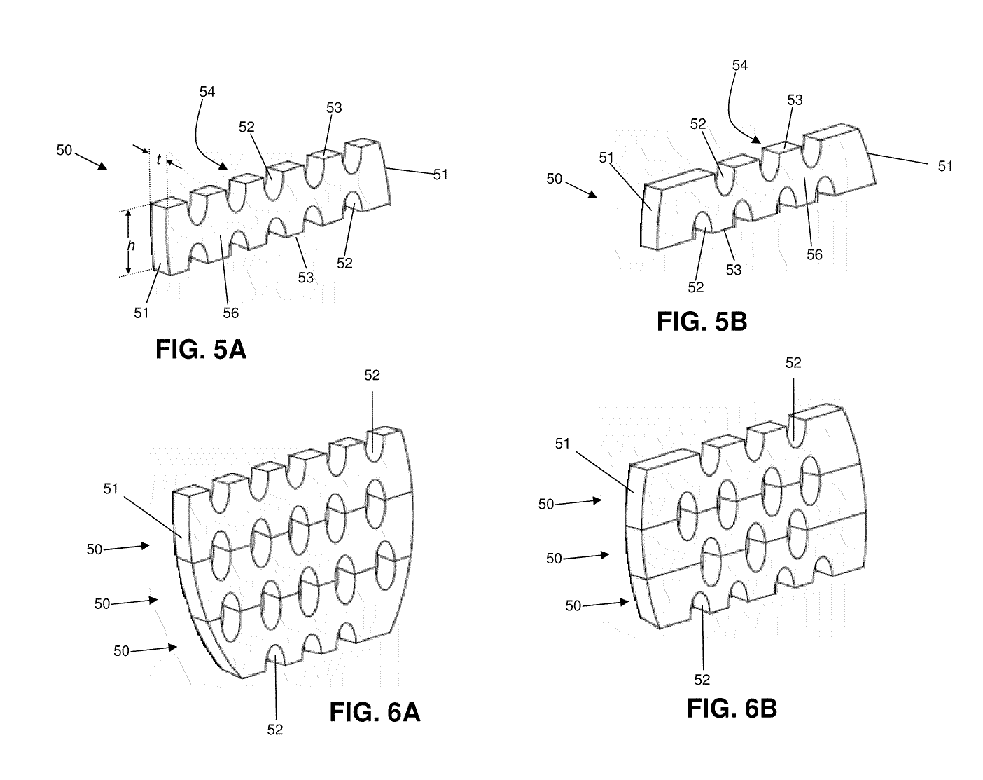

Referring now to FIGS. 5A, 6A and 7A, an apparatus and method of the present invention is shown for supporting a tube set that is disposed in a square configuration. One having ordinary skill in the art will appreciate that the apparatus and method is equally applicable to a tube set disposed in a triangular configuration, and corresponding illustrations are shown in to FIGS. 5B, 6B and 7B.

An apparatus of the present invention includes one or more elongated support members 50 attached to a baffle plate 30. The elongated support member 50 include end surface portions 51, i.e., on the side edges, and a plurality of contoured tube-contacting surfaces 52 on each of its upper and lower edges, which are configured, positioned and dimensioned to receive in close-fitting relation the exterior surface of a portion of adjacent rows of tubes 26 passing through the baffle aperture 32. Accordingly, in a bundled tube heat exchanger having tubes 26 of circular cross-section, the configuration of the contoured tube-contacting surfaces 52 is semicircular, dimensioned with a radius matched to the radius of the outside surface of the tubes 26, and positioned corresponding to the spacing of the tubes 26.

On each side, between the contoured tube-contacting surfaces 52, the flat surfaces denoted 53 in FIGS. 5A-6B are referred to as edge portions. Note that while both edges of the elongated support member 50 are shown having contoured tube-contacting surfaces 52, one of ordinary skill in the art will appreciate that an elongated support member can have one edge with contoured tube-contacting surfaces 52, for instance, for positioning adjacent to the bottom row of baffle apertures or the top row of baffle apertures 32.

The elongated support member 50 further includes a face contact surface 54 and an opposing surface 56, and is positioned so that the face contact surface 54 is adjacent to a face surface of the baffle 30. In this position, the contoured tube-contacting surfaces 52 are adjacent to and in close-fitting relation with the exterior surfaces of opposing rows of tubes 26 at contact points 58.

In a method of manufacturing a tube set 24 for a bundled tube heat exchanger 20, the tube set 24 is provided to include a plurality of tubes 26 supported on their ends by tube sheets 28 having apertures defining the pattern of the plurality of tubes, and one or more baffles 30 intermediate the distal ends of the tube set 24. The baffles 30 include a face surface having apertures 32 corresponding to the pattern of the tube set 24, and as discussed above, the apertures are somewhat larger than the outer diameter of the tubes 26 that pass through those apertures, with a clearance region 33 as shown in FIG. 4. One or more elongated support members 50 are positioned so that the face contact surface 54 of the elongated support members 50 is adjacent to the face surface of the baffle 30, and the contoured tube-contacting surfaces 52 are positioned adjacent the exterior surfaces of the plurality of tubes 26. The one or more elongated support members 50 are attached to the face surface of the baffle 30.

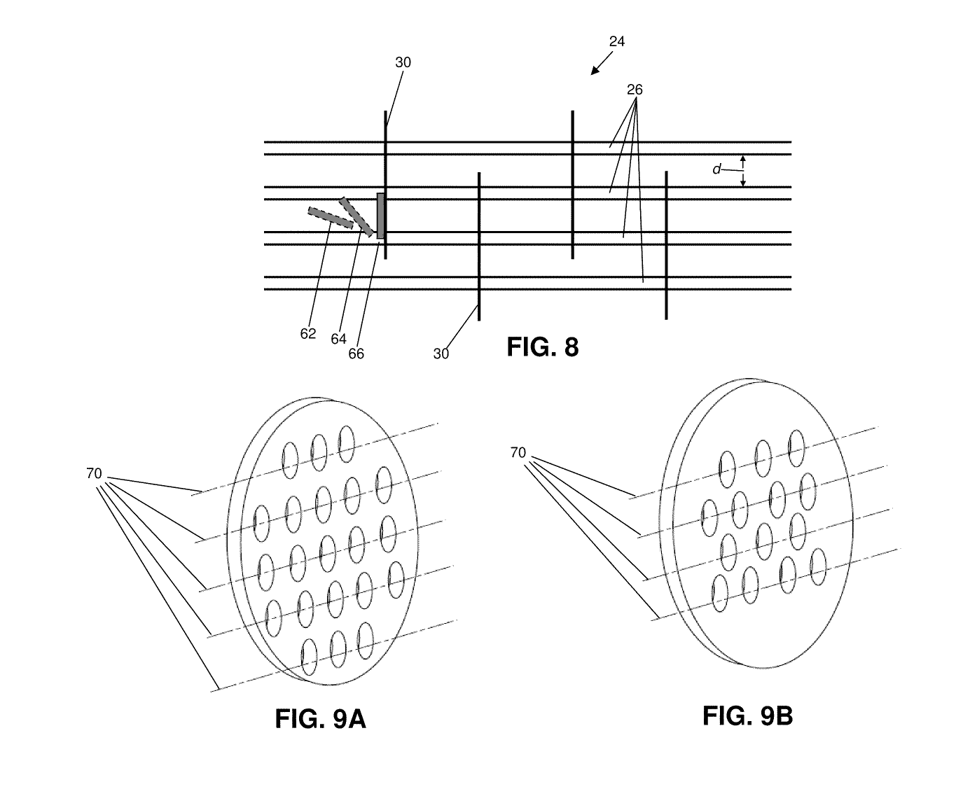

In certain embodiments, a method is provided to facilitate insertion of the one or more elongated support members 50 between the tubes 26 of the tube set 24. Referring to FIG. 5A and also to FIG. 8, note that the maximum height dimension h between the distal top and bottom edges 53 of the of the elongated support member 50 is greater than then distance d between adjacent rows of tubes 26, since the contoured tube-contacting surfaces 52 are concave to accommodate the outer surface of the tubes 26. Note that the dimension between the apexes of the concave contoured tube-contacting surfaces 52 on opposing edges of the elongated support members 50 correspond to the spacing between adjacent rows of tubes 26. Insertion of the elongated support member 50 by passing it through the tube set 24 in the orientation at which it will ultimately be placed, i.e., parallel to the baffle 30, can disadvantageously result in scraping of the edges of the one or more elongated support members 50 against the tubes. Accordingly, as shown in FIG. 8, one or more elongated support members 50 are inserted 62 at an angle other than parallel to the baffle 30. The elongated support member 50 is rotated, as shown at 64, into the final position 66, adjacent to the baffle 30, that the face contact surface 54 of the elongated support member 50 is adjacent to the face surface of the baffle 30 and the opposed contoured tube-contacting surfaces 52 are adjacent to the exterior surfaces of the plurality of tubes 26. Accordingly, the thickness dimension t of the elongated support member 50 is less than the dimension d between adjacent rows of tubes 26.

In certain embodiments, the elongated support members 50 are provided with a very high precision, i.e., close degree of tolerance. This can be facilitated by constructing the elongated support member 50 from an end plate, e.g., the tube sheet 28, manufactured according to the specifications of the heat exchanger 20. Such a tube sheet 28 includes apertures that are substantially the same as the outside diameters of the tubes 26, and correspond precisely with the configuration of, and dimensions between, the tubes. The elongated support members 50 are formed by cutting such end plate along parting lines 70 shown in FIG. 9A with respect to a square configuration tube set, and in FIG. 9B with respect to a triangular configuration tube set.

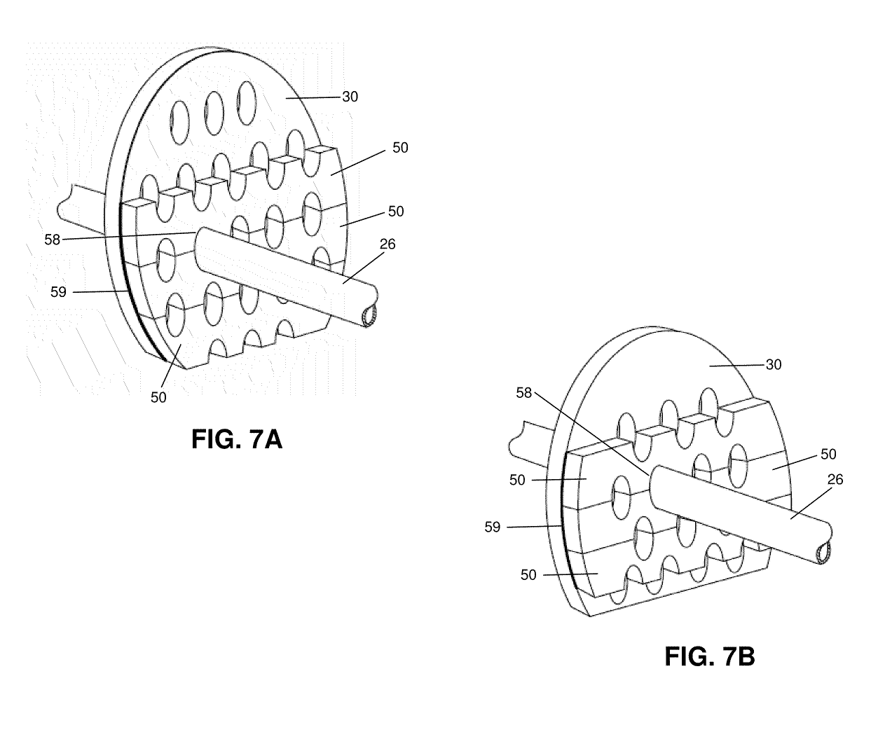

The one or more elongated support members 50 can be attached to the baffle 30 by welding at its ends, providing through holes and bolting or riveting, or utilizing a suitable adhesive material that is compatible with the heat receiving fluid and able to withstand the temperatures to which it will be exposed in the heat exchanger. In certain preferred embodiments, the one or more elongated support members 50 are attached to the baffle 30 by welding at or proximate to the contact interface between the distal end portions 51 and the adjacent edge portions of the baffle 30, shown as welds 59 in FIGS. 7A and 7B. By welding at the edges, a plurality of elongated support members 50 can be stacked atop one another against the baffle 30 as depicted in FIGS. 7A and 7B and circumferentially supporting the tubes 26.

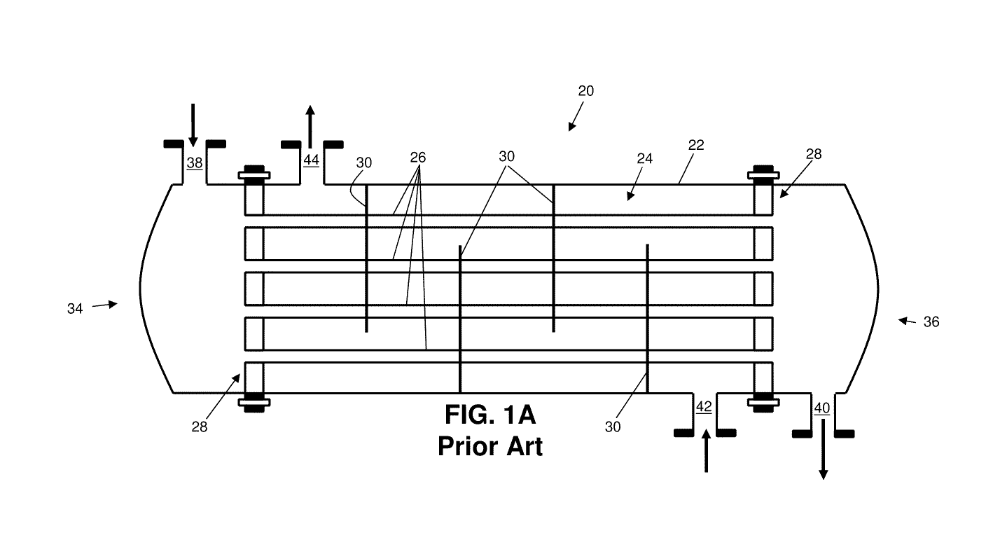

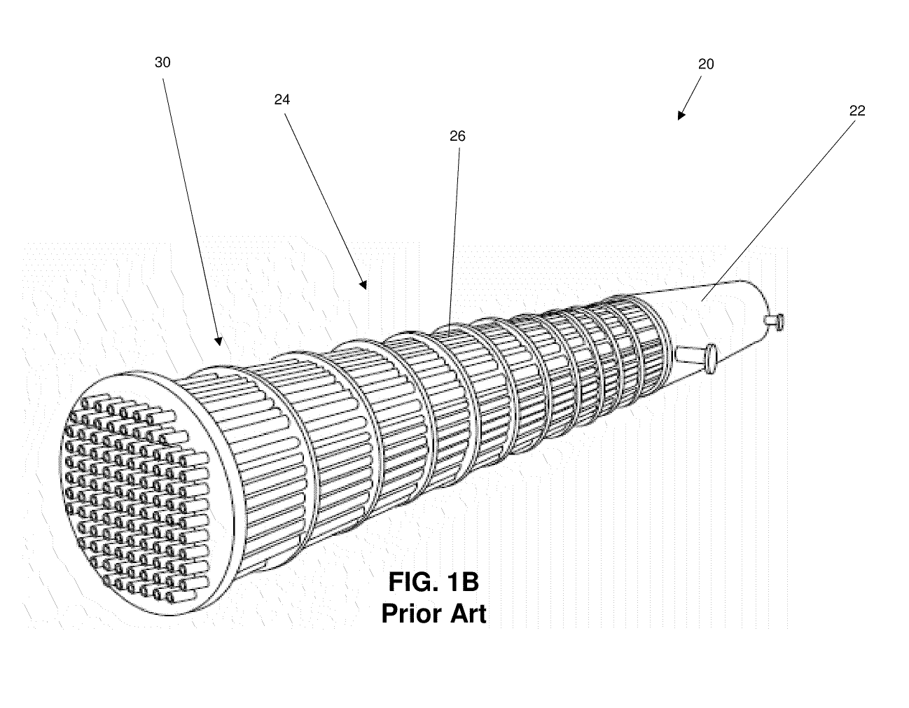

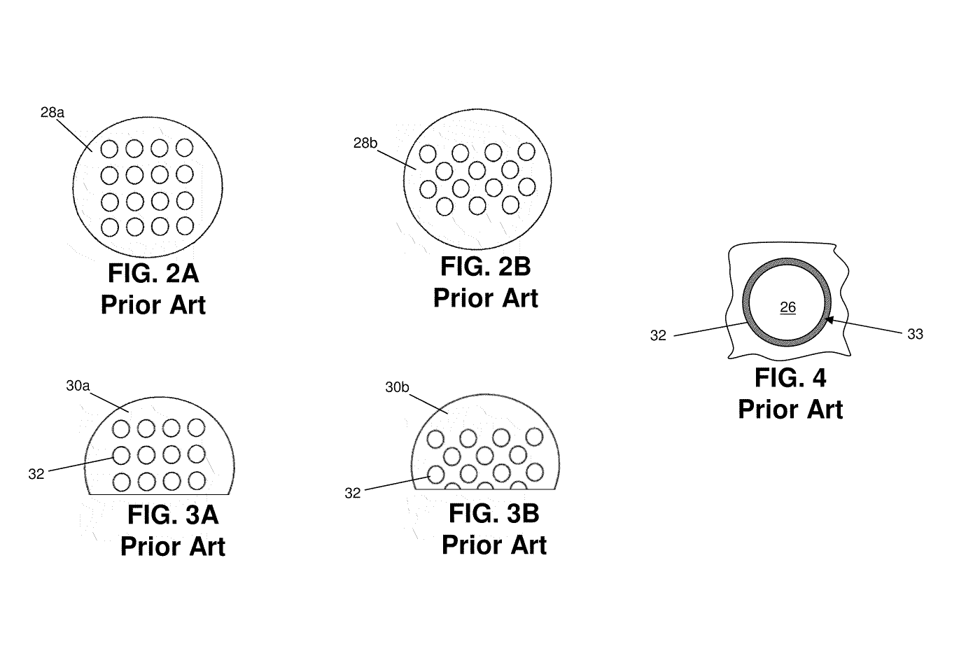

In a method of repairing and/or upgrading a bundled tube heat exchanger 20, the tube set 24, in its entirety, is removed from the shell 22 as shown in FIG. 1B. One or more elongated support members 50 are provided and positioned so that the face contact surface 54 is adjacent to the face surface of a baffle 30, and the opposed contoured tube-contacting surfaces 52 positioned adjacent the exterior surfaces of a plurality of the tubes 26. One or more elongated support members 50 are attached to the baffle 30, e.g., by welding. The tube set 24 is then reinserted into the shell 22.

Benefits of the present invention are demonstrated with reference to deflection of a beam of length L=a+b, with both ends fixed. In the context of a tube in a tube set, the ends are fixed by the end plates. Deflection y of the tube of length L (span) due to a concentrated load P is given by:

$$\begin{matrix}y ( x ) = \frac{{Pb}^{2} {x}^{2}}{6 {EIL}^{3}} [ 3 aL - x ( 3 a + b ) ] for 0 \leq x \leq a ; and & ( 1 ) \\ y ( x ) = \frac{{{Pa}^{2} ( 1 - x )}^{2}}{6 {EIL}^{3}} [ 3 bL - ( L - x ) ( 3 b + a ) ] for 0 \leq x \leq b , & ( 2 )\end{matrix}$$

where x is the distance between the baffle and the applied load P, E is the modulus of elasticity of the beam, and I is the area moment of inertia. Maximum deflection occurs with a=b=L/2, and is given by:

$${y}_{( L / 2 )} = \frac{{PL}^{3}}{192 EI} . \qquad ( 3 )$$

Assuming that the pressure from one side of the tube is uniform, i.e., a concentrated load acting at the middle of length L, the vibration stiffness of the tube due to fundamental bending can be extracted from Equation (3) as follows:

$${k}_{bending} = \frac{192 EI}{{L}^{3}} . \qquad ( 4 )$$

According to the present invention, tubes are structurally supported at one or more positioned between the endplates. Considering two different lengths of tubes L₁ and L₂ where L₂=L₁/2, which is equivalent to incorporating a single elongated support member for a tube at a baffle midway between the endplates, the ratio of the stiffness will be:

$$\frac{{k}_{2}}{{k}_{1}} = 8. \qquad ( 5 )$$

The deflection ration, noting that P₂=P₁/2 is:

$$\frac{{y}_{2}}{{y}_{1}} = \frac{1}{16} . \qquad ( 6 )$$

Accordingly, the tube has been stiffened by 8 times and the maximum deflection has been reduced by 16 times under the same uniform pressure.

### Example

Using commercially available finite element analysis software such as that sold by ANSYS, Inc., Canonsburg, Pa., USA, four selected lengths of tubes were simulated. Maximum deflection and the level of von Mises yield criterion are presented in Table 1 below:

| | Maximum | Maximum von | Expected |
|---|---|---|---|
| | Deflection | Mises stress at joints | Tube |
| Tube Length (mm) | (mm) | (MPa) | Thinning |
| L1 = 637 + L3 + 13(L4) | 4.263 | 0.831 × 10⁷ | Yes |
| L2 − L3 + 6(L4) | 0.225748 | 0.188 × 10⁷ | Yes |
| L3 = 745 | 0.001115 | 123017 | No |
| L4 = 345 | .535 × 10⁻⁴ | 23855 | No |

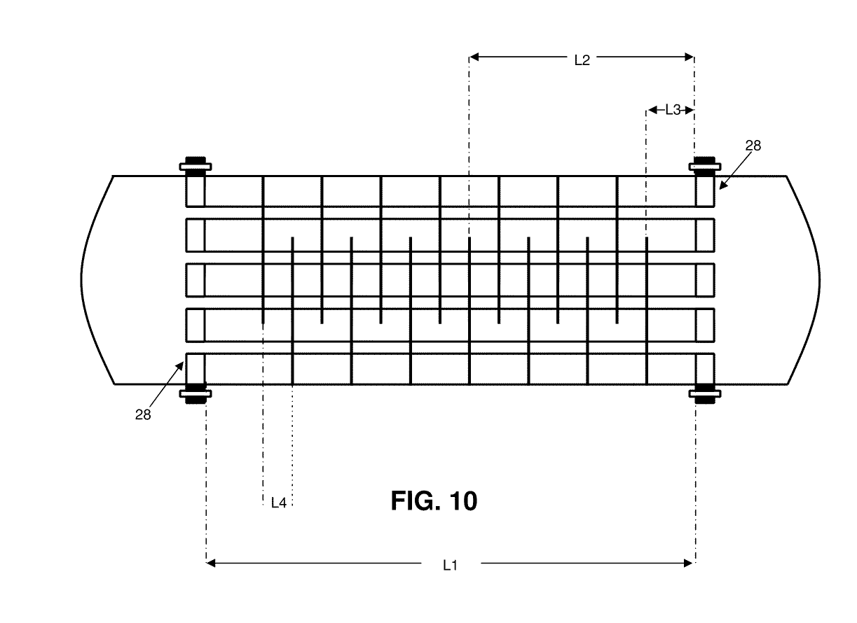

The selected lengths L2, L3 and L4 are based on the location of the baffles in the heat exchanger, and L1 is based on the length from endplate to endplate, as indicated in FIG. 10. Thinning can be ascertained by comparing the deflection level with the actual clearance (shown in FIG. 4 as reference numeral 33) of 0.1 mm between the tube 26 and the baffle aperture 32. Accordingly, deflection for L3 and L4 are much less than 0.1 mm, hence no thinning is expected.

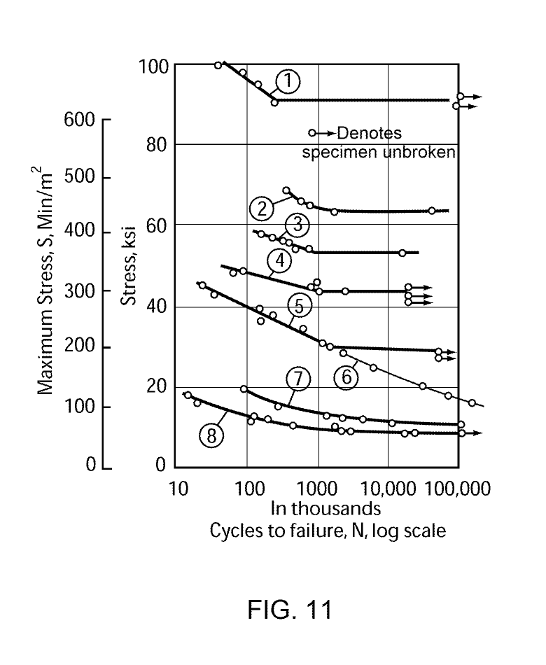

Referring also to FIG. 11, the S-N diagram from fatigue tests for various materials is provided. In particular, useful for reference herein is (2) alloy structural steel, (4) SAE 4130, normalized and annealed, and (5) ordinary structural steel. Since the deflections are reduced in case of L3 & L4, the stressed are also reduced. The control factor is the deflection.

The method and system of the present invention have been described above and in the attached drawings; however, modifications will be apparent to those of ordinary skill in the art and the scope of protection for the invention is to be defined by the claims that follow.

1. A method of manufacturing or modifying a tube set for a bundled tube heat exchanger, the tube set including a plurality of tubes supported on their ends by end plates having apertures corresponding to a pattern of the plurality of tubes and one or more baffles intermediate the distal ends of the tubes, the baffles including a face surface having apertures corresponding to the pattern of the plurality of tubes through which the plurality of tubes pass, the method comprising:
providing an elongated support member having opposed contoured tube-contacting surfaces configured, positioned and dimensioned to receive in close-fitting relation the exterior surface of a portion of adjacent rows of tubes passing through the baffle aperture, and a face contact surface;
positioning the elongated support member so that the face contact surface is adjacent to the face surface of the baffle and the opposed contoured tube-contacting surfaces are adjacent to the exterior surfaces of the plurality of tubes; and
attaching the elongated support member to the face surface of the baffle.

2. The method of claim 1, wherein the elongated support member is cut from a component dimensioned and having apertures corresponding in size and location to the end plate of the tube set.

3. The method of claim 1, wherein a plurality of elongated support members are provided, positioned and attached, each of the plurality of elongated support members positioned and attached to different adjacent rows of tubes in the tube set.

4. The method of claim 1, the adjacent rows of tubes characterized by a distance dimension therebetween, wherein the elongated support member has a thickness less than the distance dimension, and positioning comprises inserting the elongated support member through the tubes at an angle other than parallel to the baffle, and rotating to position the elongated support member so that the face contact surface is adjacent to the face surface of the baffle and the opposed contoured tube-contacting surfaces are adjacent to the exterior surfaces of the plurality of tubes.

5. The method of claim 1, wherein attaching the elongated support member to the baffle is by one or more of welding; providing through holes and bolting; providing through holes and riveting; or applying adhesive.

6. The method of claim 1, wherein attaching the elongated support member to the baffle is by welding at or proximate to a contact interface between distal ends of the elongated support member and baffle edge regions.

7. A method of modifying a bundled tube heat exchanger including a tube set and a shell, the tube set including a plurality of tubes supported on their ends by end plates having apertures corresponding to a pattern of the plurality of tubes and one or more baffles intermediate the distal ends of the tubes, the baffles including a face surface having apertures corresponding to the pattern of the plurality of tubes through which the plurality of tubes pass, the method comprising:
removing the tube set from the shell;
providing an elongated support member having opposed contoured tube-contacting surfaces configured, positioned and dimensioned to receive in close-fitting relation the exterior surface of a portion of the tubes passing through the baffle aperture, and a face contact surface;
positioning the elongated support member so that the face contact surface is adjacent to the face surface of the baffle and the opposed contoured tube-contacting surfaces positioned adjacent the exterior surfaces of the plurality of tubes;
attaching the elongated support member to the face surface of the baffle; and
inserting the tube set in the shell.

8. A tube set for a heat exchanger comprising:
a plurality of tubes supported on their ends by end plates;
at least one baffle intermediate to distal ends of the tubes, the baffle including a face surface having apertures corresponding to the pattern of the plurality of tubes through which the plurality of tubes pass;
at least one elongated support member attached to the baffle, the elongated support member having
a face contact surface adjacent the baffle and
opposed contoured tube-contacting surfaces configured, positioned and dimensioned in close-fitting relation with the exterior surface of a portion of the tubes passing through baffle apertures.

9. The tube set as in claim 8, wherein stiffness of the tubes is increased by a factor of at least eight (8).

10. The tube set as in claim 8, wherein the maximum deflection of the tubes is decreased by a factor of at least sixteen (16).

11. A baffle assembly for a heat exchanger including a tube set, the baffle comprising:
a plurality of apertures positioned, configured and dimensioned to allow a plurality of tubes of the tube set to pass through the baffle;
at least one elongated support member attached to the baffle, the elongated support member having
a face contact surface adjacent the baffle and
opposed contoured tube-contacting surfaces configured, positioned and dimensioned to be close-fitting relation with the exterior surface of a portion of the tubes to pass through baffle apertures.
